(19) United States
(12) Patent Application Publication
(10) Pub. No.: US 2007/0025338 A1
(43) Pub. Date: Feb. 1, 2007

(54) Software-based solutions for telephone network bridging

(75) Inventors: Yuri Benditovich, Netanya (IL); Avi Avrahami, Koshav-Yair (IL)

Correspondence Address: LADAS & PARRY, 26 WEST 61ST STREET, NEW YORK, NY, 10023, US

(73) Assignee: SMARTLINK LTD..

(21) Appl. No.: 11/326,587

(22) Filed: Jan. 5, 2006

Related U.S. Application Data
(63) Continuation-in-part of application No. 11/243,135, filed on Oct. 4, 2005.
(60) Provisional application No. 60/702,273, filed on Jul. 26, 2005.

(51) Int. Cl. H04L 12/66; H04L 12/56

(52) U.S. Cl. 370/352; 370/401

(57) ABSTRACT

A computer-implemented method for communication includes coupling a computer to communicate over a circuit-switched telephone network via voice-band analog modem hardware. A communication terminal is coupled to exchange digital voice samples with the computer via a digital interface. A telephone call is established via the computer between the communication terminal and a telephone on the circuit-switched telephone network wherein the voice-band analog modem hardware transmits and receives voice signals corresponding to the digital voice samples over the circuit-switched telephone network to and from the telephone.

### CROSS-REFERENCE TO RELATED APPLICATIONS

This application claims the benefit of U.S. Provisional Patent Application 60/702,273, entitled “Bridging VOIP Network and PSTN Network by Using a Dial-Up Voice-Band Modem,” filed Jul. 24, 2005. This application is a continuation-in-part of U.S. patent application Ser. No. 11/243,135, filed Oct. 25, 2005. Both of these related applications are assigned to the assignee of the present patent application, and their disclosures are incorporated herein by reference.

### FIELD OF THE INVENTION

The present invention relates generally to computer-integrated telephony, and specifically to methods and devices for integrating packet-switched and circuit-switched telephone equipment and services.

### BACKGROUND OF THE INVENTION

Analog telephone adapters are devices that convert the analog signals from a conventional telephone into a format acceptable for transmission over an Internet connection, and vice versa at the receiving end. A variety of products of this sort are available on the market. Examples include the HandyTone series, produced by Grandstream Networks; Sipura Phone Adapters, produced by Sipura Technology, Inc. (recently acquired by Cisco Systems); Quadro® Voice Routers, produced by Epygi® Technologies, Ltd.; FXS VoIP Gateway, produced by Micronet®; Messenger Call Box, produced by BAFO Inc.; Actiontec® Internet Phone Wizard, produced by Actiontec Electronics, Inc.; and M3 Motorola® Messenger Modem, produced by Motorola, Inc.

Various types and features of analog telephone adapters are described in the patent literature. For example, U.S. Pat. No. 6,700,956, whose disclosure is incorporated herein by reference, describes apparatus for selectively connecting a telephone to a telephone network or to the Internet. The apparatus comprises a hardware module and associated software for coupling a personal computer or Internet appliance and a standard analog telephone. The apparatus permits the analog telephone to be toggled between an Internet-based telephone mode and a public switched telephone network (PSTN) mode by inputting a predetermined sequence of dual-tone multi-frequency (DTMF) digits.

U.S. Pat. No. 6,731,751, whose disclosure is incorporated herein by reference, describes interface apparatus, which is interposed between a cordless telephone base unit and a personal computer sound card. The interface emulates a central office connection with respect to the telephone and a microphone and speaker connection with respect to the computer sound card.

U.S. Pat. No. 6,711,160, whose disclosure is incorporated herein by reference, describes an interface unit between a telephone and a packet network. The unit also functions as a gateway between a packet network and a public switched telephone network (PSTN). When power is not supplied to the unit, a fallback switch automatically links the telephone instrument directly to the PSTN, bypassing the circuitry in the unit. The unit also includes an LCD driver and a display for showing information such as caller identification.

It is also possible to place and receive Voice over Internet Protocol (VoIP) calls using a dedicated USB phone connected to a personal computer. A USB phone typically comprises a telephone handset, including a speaker and microphone, along with a built-in audio codec and an interface to the computer's Universal Serial Bus (USB) port. For example, Skype™ Technologies S.A. (www.skype.com) offers the CyberPhone K and Simply Phones, which plug into the USB port and interface with Skype VoIP soft phone application software on the computer. The USB phone may also include other user interface elements, such as a keypad and display. TigerJet Network Inc. (www.tjnet.com) offers the Tiger560B chip and reference designs that may be used in producing USB phones with these and other features.

### SUMMARY OF THE INVENTION

Embodiments of the present invention provide devices and methods for bridging between circuit-switched and packet-switched telephone functions, with reduced hardware requirements relative to solutions known in the art.

In one aspect of the present invention, a computer is connected to a circuit-switched telephone network, such as a PSTN, via a voice-band analog modem. Such modems are built into most personal computers that are currently on the market. Typically, the computer is also connected to a packet network, such as the Internet, via a broadband modem, and is configured to place and receive packetized voice calls (such as VoIP calls) over the packet network. The computer is programmed to use the voice-band modem as an analog front end in order to place and receive telephone calls via the circuit-switched telephone network. In this manner, the computer can serve as a bridge for placing voice calls between digital communication terminals and telephones on the circuit-switched networks. The digital communication terminal may be connected locally to the computer, or it may alternatively be linked remotely to the computer, via the packet network.

In some embodiments of the present invention, the digital communication terminal comprises a digital telephone terminal, which is coupled as an input/output (I/O) device for use in placing and receiving telephone calls via the computer. The term “digital telephone terminal,” as used in the context of the present patent application and in the claims, refers to a self-contained telephone device that comprises a speaker and microphone, along with an analog front end connected to these audio elements and a digital interface to the computer. A USB phone, as described above, is a typical example of such a terminal. In a disclosed embodiment, a user employs the digital telephone terminal not only for VoIP calls over the Internet, but also to place and receive analog calls over the circuit-switched telephone network using the voice-band analog modem and software described above. Thus, in this exemplary embodiment, interworking between analog telephony and VoIP functions is achieved without the use of a dedicated analog telephone adapter or other hardware external to the computer and digital telephone terminal.

In an alternative embodiment, the user employs a digital telephone terminal and computer in conjunction with a dedicated analog adapter for interfacing to the circuit-switched telephone network. In another alternative embodiment, the user employs an analog telephone adapter for interfacing a conventional analog telephone to the computer, which interfaces to the circuit-switched telephone network via a voice-band analog modem.

Regardless of the specific hardware configuration that is chosen, embodiments of the present invention permit the computer to carry out novel network bridging and user interface functions. For example, the computer may detect ringing and caller ID signals on the circuit-switched telephone network line, even when the computer is in use on a VoIP call, and may then notify the user of the incoming telephone call. Furthermore, the computer may transcode different types of caller ID signals between the circuit-switched telephone network and the packet network, and may cause the transcoded information to be shown on the telephone display, as well as on the computer screen. Additional functions that may be implemented in the context of the present invention are described in the above-mentioned U.S. patent application Ser. No. 11/243,135, as well as in U.S. patent application Ser. No. 11/211,361, filed Aug. 25, 2005, which is assigned to the assignee of the present patent application and whose disclosure is incorporated herein by reference.

There is therefore provided, in accordance with an embodiment of the present invention, a computer-implemented method for communication, including:
coupling a computer to communicate over a circuit-switched telephone network via voice-band analog modem hardware;
coupling a communication terminal to exchange digital voice samples with the computer via a digital interface; and
establishing a telephone call via the computer between the communication terminal and a telephone on the circuit-switched telephone network wherein the voice-band analog modem hardware transmits and receives voice signals corresponding to the digital voice samples over the circuit-switched telephone network to and from the telephone.

In some embodiments, coupling the communication terminal includes connecting a digital telephone terminal to a digital input/output (I/O) port of the computer. Typically, the digital I/O port includes a Universal Serial Bus (USB) port, or alternatively, a computer bus connection or a digital audio connection. In a disclosed embodiment, the method includes establishing a Voice over Internet Protocol (VoIP) call via the computer between the digital telephone terminal and a remote communication terminal over a packet-switched network. Establishing the VoIP call may include receiving at the computer, via the digital I/O port, an input corresponding to one or more keystrokes input by a user of the digital telephone terminal, and processing the input, using the computer, so as to determine whether to establish the telephone call or the VoIP call.

Additionally or alternatively, establishing the telephone call may include driving the communication terminal, using the computer, to generate a first audible indication to indicate that the telephone call has been received from the circuit-switched communication network, and establishing the VoIP call may include driving the communication terminal, using the computer, to generate a second audible indication, different from the first audible indication, to indicate that the VoIP call has been received from the circuit-switched communication network.

In other embodiments, coupling the communication terminal includes setting up a link between the communication terminal and the computer via a packet network. Typically, setting up the link includes establishing a Voice over Internet Protocol (VoIP) call between the communication terminal and the computer.

In disclosed embodiments, establishing the telephone call includes conveying the digital voice samples in the computer between a modem driver program that is used to control the voice-band analog modem hardware and a soft phone application program via an audio driver program. In one embodiment, establishing the telephone call includes controlling the telephone call using a soft phone agent, and the digital voice samples are conveyed between the modem driver program and the audio driver program via the soft phone agent.

In another aspect of the present invention, establishing the telephone call includes receiving a caller identification (CID) signal from the telephone over the telephone network, and outputting a message via the digital interface so as to cause the communication terminal to display information corresponding to the CID signal.

In some embodiments, the voice-band analog modem hardware is configured to operate in conjunction with a software modem.

There is also provided, in accordance with an embodiment of the present invention, apparatus for communication, including:
a communication terminal; and
a computer, which includes:
a digital interface, which is arranged to exchange digital voice samples with the communication terminal; and
voice-band analog modem hardware, which is arranged to communicate over a circuit-switched telephone network,
the computer being arranged to establish a telephone call between the communication terminal and a telephone on the circuit-switched telephone network wherein the voice-band analog modem hardware transmits and receives voice signals corresponding to the digital voice samples over the circuit-switched telephone network to and from the telephone.

There is additionally provided, in accordance with an embodiment of the present invention, a computer software product, including a computer-readable medium in which program instructions are stored, which instructions, when read by a computer, cause the computer to communicate over a circuit-switched telephone network via voice-band analog modem hardware, and to exchange digital voice samples with a communication terminal via a digital interface, and to establish a telephone call between the communication terminal and a telephone on the circuit-switched telephone network wherein the voice-band analog modem hardware transmits and receives voice signals corresponding to the digital voice samples over the circuit-switched telephone network to and from the telephone.

The present invention will be more fully understood from the following detailed description of the embodiments thereof, taken together with the drawings in which:

### BRIEF DESCRIPTION OF THE DRAWINGS

FIG. 1 is a schematic, pictorial illustration of a telephone communication system, in accordance with an embodiment of the present invention;

FIG. 2 is a block diagram showing functional details of a telephone communication system, in accordance with an embodiment of the present invention;

FIG. 3 is a block diagram that schematically shows details of software that runs on a computer used in telephone network bridging, in accordance with an embodiment of the present invention; and

FIG. 4 is a block diagram that schematically shows details of software that runs on a computer used in telephone network bridging, in accordance with another embodiment of the present invention.

### DETAILED DESCRIPTION OF EMBODIMENTS

### System Overview

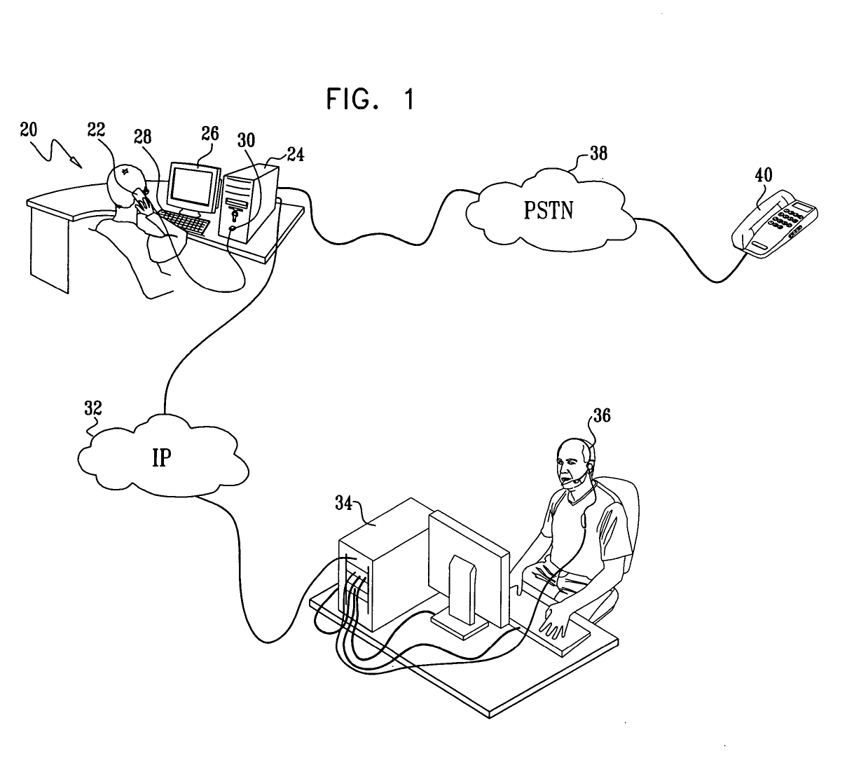

FIG. 1 is a schematic, pictorial illustration of a telephone communication system 20, in accordance with an embodiment of the present invention. System 20 combines conventional analog and packet-switched telephone network hardware components using a computer 24, typically a personal computer (PC), to provide a novel set of features and functions, which are described hereinbelow. Computer 24 comprises a user interface including a display 26 and one or more input devices 28, such as a keyboard or mouse. Alternatively, computer 24 may comprise any other sort of suitable computing device having a CPU and appropriate I/O interfaces and software; and computer 24 is referred to hereinbelow as a PC solely by way of example, and not limitation.

A user of computer 24 may place calls via the computer using a suitable audio I/O device, which connects to a digital I/O port of the computer. In the embodiments described hereinbelow, the user employs a USB phone 22, which plugs into a USB port 30 on the computer, for this purpose. Alternatively, the user may employ a digital telephone terminal of another type, which may be connected to computer 24 via a suitable wired or wireless digital interface. For example, the digital I/O port may comprise a PC bus connection, such as a Peripheral Component Interface (PCI) bus connection, or a digital audio connection, such as an Intel® High Definition (HD) Audio or AC-Link connection. Further alternatively, in alternative embodiments, the user may employ an analog telephone, which is connected to computer 24 through a suitable analog telephone adapter, as described, for example, in the above-mentioned U.S. patent application Ser. No. 11/243,135, or the user may simply employ a microphone and speaker that are connected directly to the audio system of the computer.

Computer 24 communicates with a circuit-switched telephone network 38. Typically, network 38 comprises a PSTN, and the computer connects to the PSTN via a wired connection. A voice-band analog modem (not shown in FIG. 1) that is installed in or otherwise connected to the computer may be used for this purpose, as described hereinbelow. Alternatively, network 38 may comprise another type of circuit-switched telephone network, such as a cellular network. Further alternatively, computer 24 may communicate with the circuit-switched telephone network via an external telephone line adapter (not shown). Computer 24 is configured, as described hereinbelow, to permit the user to place and receive telephone calls using USB phone 22 via network 38 to and from analog telephones 40 on the network. For clarity in the description that follows, such calls may be referred to as “PSTN calls,” but it will be understood that calls on other types of circuit-switched networks may be handled in similar fashion.

Computer 24 is also connected to a packet-switched network 32, such as the Internet, via a suitable modem (not shown in this figure). Typically, in order to enable high-quality VoIP service, the connection to network 32 is a broadband connection, such as a Digital Subscriber Line (DSL), cable modem or Integrated Services Digital Network (ISDN) connection. Alternatively, a voice-band modem connection, such as a V.90 or V.92 modem connection, may be adequate for some VoIP applications. The user of computer 24 is then able to employ USB phone 22 as an I/O device for placing and receiving VoIP calls via network 32 to and from other digital communication terminals, such as a computer 34 that is equipped with suitable VoIP software and audio interface equipment 36, as well as with non-PC VoIP devices.

Additionally or alternatively, computer 24 may serve as a bridge for calling between circuit-switched network 38 and packet network 32, with or without the involvement of the user of computer 24. For example, the computer may be employed by the user of computer 34 in placing a call to analog telephone 40, and vice versa, without the involvement of the user of computer 24. As another example, the user of computer 24 may conduct a conference call with computer 34 and telephone 40 over networks 32 and 38 simultaneously.

### Hardware and Software Components

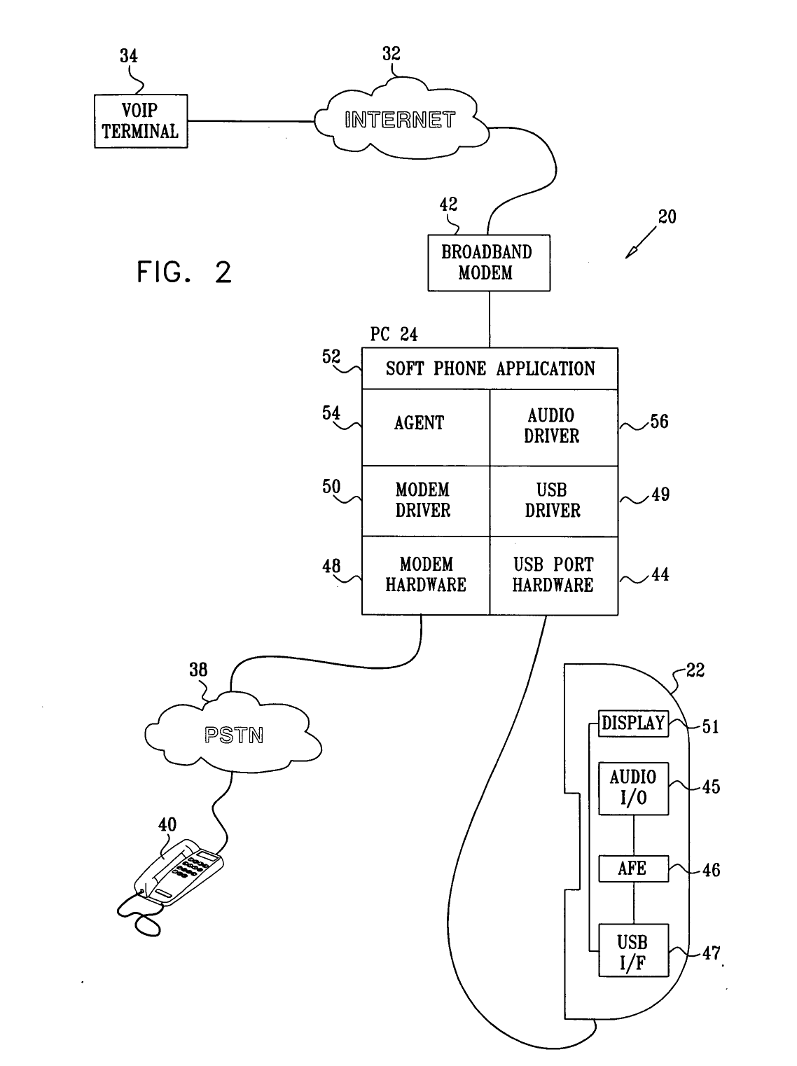

FIG. 2 is a block diagram that schematically shows functional details of system 20, in accordance with an embodiment of the present invention. Computer 24 connects to packet network 32 via a broadband modem 42, as described above, and to circuit-switched network 38 via voice-band analog modem hardware 48. The voice band is known in the art as the range of frequencies up to about 4 kHz, and the term “voice-band analog modem” is used in the present patent application and in the claims to refer to modems that operate by generating and receiving analog signals in this frequency range. Voice-band modem hardware that is known in the art typically comprises a codec, which interfaces with the telephone line. The codec serves as an analog front end (AFE) and performs analog/digital and digital/analog conversion functions. The modem hardware is controlled by modem driver software 50 that runs on the computer. Hardware 48 may also comprise a digital signal processor, which performs digital processing of modem signals in accordance with voice-band modem standards. Alternatively, the digital signal processing may be performed in software by driver 50 or other by soft modem application software running on the computer. A modem that operates in this manner is referred to as a “software modem” or “host-based modem.” In the past, modem hardware 48 was typically located on an expansion card plugged into the computer bus or in an external box. Many computers now include such modem hardware on the motherboard.

Typically, modem hardware 48 and driver 50 also have a built-in voice mode, in which digital audio samples may be transferred to and from application software on computer 24 while bypassing the modem digital signal processing. The audio samples in this case are typically processed instead by audio driver software 56 running on the computer. The voice mode is invoked by submitting a suitable software command to an application program interface (API) provided by driver 50. This mode of operation is used in embodiments of the present invention for handling telephone calls to and from network 38.

USB phone 22 comprises audio I/O circuits 45, including a speaker, microphone, and optionally a tone generator, for generating ring, call waiting, and other tones. The audio I/O circuits are connected to a USB interface (I/F) circuit 47 via an AFE 46 (also referred to as a codec), which performs analog/digital and digital/analog conversion functions. The USB interface circuit connects via cable to USB port hardware 44 in computer 24. Telephony application software running on computer 24 interacts with the USB port hardware by means of USB driver software 49. Digital audio samples carried via the USB port are typically handled by the application software using audio driver 56. Optionally, phone 22 may comprise other user interface elements, such as a display 51 (typically a liquid crystal display—LCD) and a keypad (not shown). The telephony application software on computer 24 interacts with these elements via USB interface 47, as described further hereinbelow.

A soft phone application 52 handles the communication tasks that are associated with placing and receiving VoIP calls over network 32 and PSTN calls over network 38. The VoIP call functions typically comprise, for example, setting up and terminating calls using the Session Initiation Protocol (SIP), and transmitting and receiving audio data packets over network 32 using the appropriate soft codec and upper-level communication protocols. The PSTN call functions typically comprise, for example, controlling the hook state of modem hardware 48 via modem driver 50, and dialing and responding to calls, as well as transmitting and receiving audio signals via audio driver 56, modem driver 50 and modem hardware 48. When appropriate, the audio data carried in the VoIP and/or PSTN calls are transferred to and from USB phone 22 via USB port hardware 44, using audio driver 56 and USB driver 49, as described above.

On the control plane, soft phone application 52 communicates with modem driver 50 via a software agent 54. The agent receives event messages from modem driver 50 and passes commands to the modem driver indicating changes in the call state. On the application side, agent 54 passes events to the soft phone application via an agent API (shown in the figures that follow) and receives instructions from the application via the API regarding handling of the call. Although the agent is shown and described as a separate software function from the soft phone application, in an alternative embodiment these functions may be integrated within a single software module.

Soft phone application 52, agent 54, and drivers 49, 50 and 56 are typically implemented in software running on computer 24. These software components may be supplied as a single package or in two or more separate packages of drivers and application software. Each of these software packages may be downloaded to computer 24 in electronic form, over network 32, for example, or they may alternatively be furnished on tangible media, such as optical, magnetic or electronic memory.

### Basic Use Scenarios

As noted above, the hardware and software configuration of computer 24 that is illustrated in FIG. 2 may be used for both placing calls to and from local USB phone 22 and for bridging of calls between packet network 32 and circuit-switched network 38. For the sake of clarity, the embodiments described hereinbelow may refer specifically to one or the other of these operating configurations—local or bridging. It will be apparent to those skilled in the art, however, that the principles of the embodiments described with respect to one operating configuration may generally also be applied, mutatis mutandis, to the other configuration.

Call from USB Phone to a PSTN Destination

In this scenario, the user of USB phone 22 dials the telephone number of a telephone on PSTN 38, such as telephone 40. The user may indicate that the call is to be placed over the PSTN by pressing a certain sequence of keys on phone 22 or on keyboard 28, or alternatively by activating a dedicated switch on the phone, for example. Further alternatively, PSTN calling may be set as the default dialing mode. Further alternatively, agent 54 or application 52 may recognize the dialed number as a PSTN number and may thus set up the PSTN call automatically.

When the user dials a PSTN number, agent 54 instructs modem driver 50 to initiate an outgoing call on PSTN 38 to the destination telephone number. For this purpose, driver 50 instructs modem hardware 48 to go off hook and to generate the appropriate sequence of tones on the telephone line in order dial the destination number.

Modem driver 50 then monitors the audio signals coming in from PSTN 38, via modem hardware 48, in order to determine call progress and status, and reports on the status to agent 54. When telephone 40 picks up, and the connection is established, agent 54 instructs modem driver 50 and hardware 48 to enter voice mode. The voice mode may comprise, for example, a Full-Duplex Speaker Phone (FDSP) mode that is offered as a standard on many voice-band analog modems. Alternatively, a special-purpose voice mode may be defined and programmed into modem driver 50. The modem driver conveys the audio samples to and from audio driver 56, which in turn passes the samples to and from USB driver 49. Agent 54 continues to monitor the call until it is disconnected by one or the other of the parties.

Call from PSTN to the USB Phone

In this case, a user of telephone 40 places a call via network 38 to the telephone line that is connected to modem hardware 48. A PSTN ring signal appears on the line and is detected either by a dedicated ring detector circuit in modem hardware 48 or by software associated with modem driver 50. The modem driver informs agent 54 of the incoming call event.

The modem driver may also detect caller identification (CID) information in the incoming call signal, and may pass this information to agent 54. CID transmission and detection are well known in the art of telephone communications. In “type 1” CID transmission, the CID of the telephone initiating a call is encoded between rings of the ring signal transmitted from the central office to the telephone that is to receive the call. In “type 2” CID transmission, the CID of the initiating telephone is encoded together with a “call waiting” signal that is transmitted when the receiving telephone is off-hook. The type 1 and type 2 CID protocols are defined in detail, for example, in TIA Standard TIA-777-A, promulgated by the Telecommunications Industry Association (May, 2003), and incorporated herein by reference.

Agent 54 informs the local user of the incoming call either by ringing the USB phone or by providing an appropriate audible and/or visual signal through computer 24. The agent may also send instructions to driver 49 that cause USB interface 47 to present the CID of the incoming call on display 51 of the USB phone. When the user answers the call, agent 54 places modem driver 50 and hardware 48 in voice mode and causes the audio samples to flow between the modem driver and USB driver 49. The call continues in this manner until one of the parties hangs up.

Packet Telephony Gateway

As noted earlier, computer 24 may serve, in conjunction with broadband modem 42, as a gateway for placing telephone calls between PSTN 38 and packet network 32. For example, a VoIP user, such as the user of computer 34, may place a call to telephone 40 in the following manner: When soft phone 52 receives an incoming VoIP call from computer 34, agent 54 is notified by means of agent API 60. If the call is not answered by user 22 within a predefined period, agent 54 picks up the VoIP call using agent API 60. Agent 54 may then present the caller 38 with an audible dial-tone or may interact with caller 38 using an interactive voice response system, by streaming digital samples through soft phone application 52. The user of computer 34 may then dial the PSTN telephone number of telephone 40 by sending digitized DTMF tones over the VoIP network through soft phone application 52. In response to these tones, agent 54 places a PSTN call to telephone 40 via modem hardware 48, and then connects the two calls together. Agent 54 may require the user of computer 34 to provide some form of identification, such as dialing a pass-code, for authentication purposes.

A similar method may be used to place calls from the packet network into a private branch exchange (PBX) or other circuit-switched telephone network. VoIP users may thus avoid or reduce long-distance telephone charges when they are traveling, for example.

Users of PSTN telephones, such as telephone 40, may also place VoIP calls by dialing in to computer 24, and then pressing an appropriate key sequence to indicate to the computer the destination of the desired VoIP call. The computer handles these calls in a manner similar to its handling of incoming PSTN calls to USB phone 22. In this case, however, rather than connecting the call to USB phone 22, Agent 54 sets up the IP leg of the bridged call through soft phone 52, and then connects the IP leg to the PSTN leg initiated by telephone 40 in order to complete the call.

As noted above, the gateway functionality of system 20 may also be used for teleconferencing and call forwarding. In the teleconference mode, a user of USB phone 22 may place or receive PSTN and VoIP calls simultaneously. Computer 24 mixes the digital audio samples from both calls and outputs the mixed sample streams to both modem driver 50 and USB driver 49, as well as in VoIP packets transmitted over network 32. In call forwarding mode, the user of system 20 may instruct computer 24 to automatically pick up and forward PSTN calls to a specified VoIP address, or to pick up and forward VoIP calls to a specified PSTN telephone number.

The gateway functions of system 20 generally do not require any user to be present at the site of computer 24 or to be involved in local operation of the computer. Despite the convenience of such unattended operation, however, it leaves the system open to abuse by hackers, who may attempt to place telephone calls through computer 24 at the expense of the (absent) computer user. To prevent unauthorized use, computer 24 may detect and verify the identity of the remote party requesting the call before actually placing the call. For example, the computer may detect the CID encoded in calls received from PSTN 38 or the equivalent ID field in packets received from network 32. The computer checks the ID value against a list of authorized IDs, and places the call only if the ID appears on the authorized list. Alternatively, the computer may ask the caller for a password. Further alternatively or additionally, computer 24 may serve as a “telephone answering machine,” which is accessible remotely from VoIP terminals.

### Detailed Software Structure and Operation

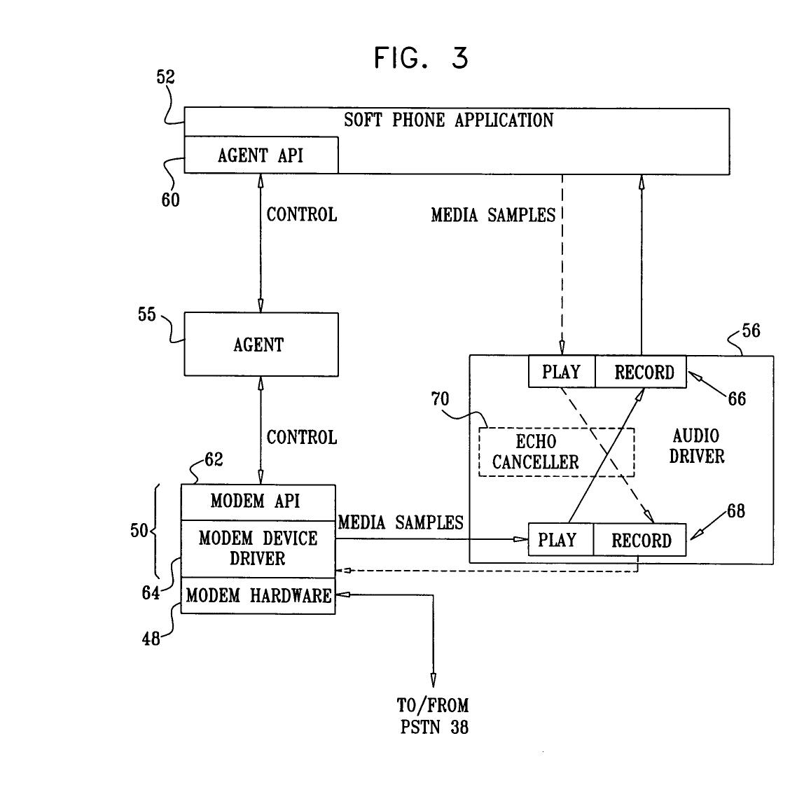

FIG. 3 is a block diagram that schematically shows details of software running on computer 24, in accordance with an embodiment of the present invention. This structure is applicable both in local use of the computer with USB phone 22 in PSTN calls and in bridging operation between networks 32 and 38.

In this embodiment, modem driver 50 comprises a modem device driver 64 and a modem API 62, through which an agent 55 communicates with the device driver. As mentioned above, agent 55 uses an agent API 60 in order to communicate with soft phone application 52. The agent uses APIs 60 and 62 to perform call control functions such as detection of call initiation events, establishing a call to the requested destination, hanging up a call, and so forth.

Audio driver 56 is a novel, special-purpose software module, which has two interfaces 66 and 68. Interface 66, which provides bi-directional streaming of digitized media (audio) samples to and from soft phone application 52, may be a standard audio API, which conforms to the requirements of the operating system of computer 24. Examples of such standard APIs include “waveform audio” and “DirectSound” APIs under the Microsoft® Windows® XP operating system. Interface 68 provides bi-directional streaming to and from modem device driver 64, either in accordance with a standard API or in a proprietary format.

Thus, in the operating configuration shown in FIG. 3, modem driver 50 works in full-duplex speakerphone mode, i.e., it does not provide an incoming digital sample stream to its controlling application (in this case—to agent 54), and it does not receive data to be transmitted from the controlling application. Instead, modem driver 50 provides an incoming digital data stream to a virtual “playback” device and receives an outgoing digital data stream from a virtual “recording” device. (Interface 68 serves as the virtual playback and recording devices.) This mode of operation is supported by industry-standard host-based and software modems that are commonly available in the market. Such modems use facilities provided by the operating system as the audio playback and recording devices.

In other words, four streams of digitized media samples flow through interfaces 66 and 68. Audio driver 56 passes the input (“play”) stream from interface 66 to the output (“record”) stream on interface 68, and vice versa.

Optionally, audio driver 56 performs additional digital signal processing functions in order to improve the quality of the audio signals. For example, the audio driver may comprise an echo canceller 70, which mutually filters the streams of samples that are transmitted to and from modem 48 in order to reduce the level of echoes. Any suitable echo processing algorithm that is known in the art may be used for this purpose.

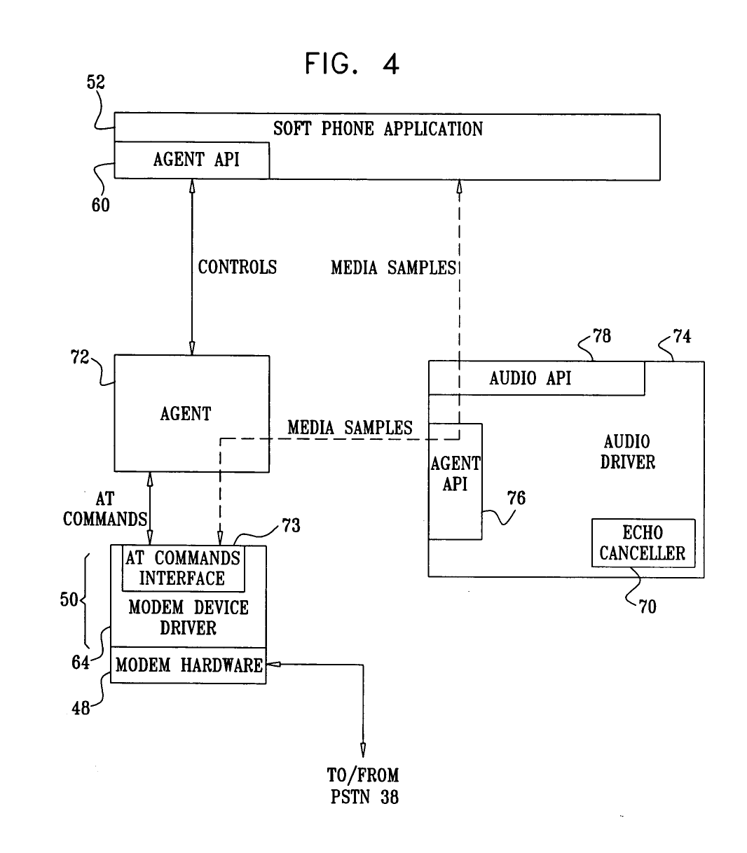

FIG. 4 is a block diagram that schematically shows details of software running on computer 24, in accordance with an alternative embodiment of the present invention. In this embodiment, modem device driver 64 communicates with an agent 72 via a conventional AT-command interface 73, as is known in the art (as specified, for example, by ITU-T Recommendation V.253). Agent 72 uses the AT-command interface for call control on PSTN 38. Bi-directional streams of media samples are conveyed between a special-purpose audio driver 74 and modem driver 50 via agent 72, through a dedicated agent API 76. Control codes may be embedded in the sample streams, to the extent that the standard interface protocol supports this sort of control signaling. (For example, according to ITU-T V.253, control codes in the sample streams are shielded by the special character sequence <DLE>.) Processing, removal, and/or stuffing the control codes inside the sample streams before passing the data to their destinations may be performed by agent 72 or audio driver 74.

Audio driver 74 conveys the media samples to and from soft phone application 52 via another audio API 78, which typically conforms to the requirements of the operating system of computer 24.

### Advanced User Interface Features

The above-mentioned U.S. patent application Ser. No. 11/243,135 describes an analog telephone adapter with dual AFEs for interfacing, respectively, to an analog telephone and to the PSTN. This hardware configuration permits the computer to control various user interface functions of the analog telephone, and thus provide a unified, digitally-controlled interface for both PSTN and VoIP calls. Similar benefits are offered by the dual AFEs in system 20: one AFE provided by modem hardware 48 and the other by AFE 46 in USB phone 22. Some exemplary functions are described hereinbelow, while further details may be found in U.S. patent application Ser. No. 11/243,135.

Computer-Mediated Dialing

When the user of USB phone 22 keys in a telephone number, computer 24 decodes the numbers that the user has dialed and determines whether to place the call through PSTN 38 or through packet network 32, as noted above. For PSTN calls, the computer may wait to generate the sequence of tones required to dial the number via modem hardware 48 until the user has finished pressing the complete keypad sequence. This feature permits the user to dial the entire number, check that the number is correct (by observing display 51, for example), and only then indicate to the computer that the number should be dialed, typically by entering another keystroke, such as “Send” or the “#” key. Computer-aided speed dialing may also be provided in this manner.

As another option, the user may speak into telephone 22 in order to cause the computer to dial a call. In this case, AFE 46 digitizes the user's voice signal, and the computer analyzes the digitized voice signal in order to decode the telephone number or name of the person to be called.

Software-Controlled Ring Generation

As noted above, computer 24 may generate an audible indication (ring output) to USB phone 22 upon receiving an incoming PSTN or VoIP call. The ring patterns that are generated for the two types of calls may be identical, or they may alternatively be different in order to give the user an audible cue as to the type of call that is coming in. Similarly, the computer may generate different ring patterns depending on the identity of the party originating the call. For this purpose, the computer decodes the CID that is encoded in the incoming PSTN call or a comparable user ID field in the packets initiating the VoIP call (such as the host name or IP address in the Call-ID specified in SIP packets). The computer compares the decoded value to a look-up table or other logic that indicates the type of ring to be generated in each case.

Computer 24 may also superimpose a brief tone on the digital audio samples that it outputs to USB phone 22 during a call in order to indicate to the user that another call is waiting. This functionality may be invoked (at the user's option) whenever the telephone is off hook, regardless of whether the user is currently on a PSTN call or a VoIP call. It may be used to indicate to the user that either a PSTN or a VoIP call is waiting. The computer may vary the call waiting tone depending on the type of call and/or identity of the calling party, just as it may generate different ring types, as described above. The computer may also generate a CID signal, so that phone 22 presents a call-waiting indication and the identity of the calling party on display 51. Additionally or alternatively, the computer may present a call-waiting message on display 26 in conjunction with the call-waiting tone and/or other indication transmitted via telephone 30 (or without such a call-waiting tone or indication).

CID Transcoding

When computer 24 receives an incoming call, it determines a CID value to associate with the call. For this purpose, when the computer receives an incoming call from PSTN 38, modem hardware 48 digitizes the encoded CID signal (type 1 or type 2), and computer 24 analyzes the digital samples in order to decode the CID. For VoIP calls, the computer decodes the user ID field from incoming VoIP packets and chooses a corresponding CID value for output to phone 22. The computer then generates an appropriate digital command encoding the CID value for output to USB driver 49. In response to the command, USB phone 22 typically rings (or plays a call waiting signal if the phone is in use) and presents the CID value on display 51.

Computer 24 may also perform transcoding of PSTN CID to VoIP user ID. This feature is useful, for example when system 20 is used as a packet telephony gateway, as described above. When the user of telephone 40 dials into system 20 in order to place a VoIP call, the incoming call signal received from the telephone line includes the CID of telephone 40. Computer 24 decodes the CID and then inserts a corresponding value (such as a VoIP user ID or name) into the VoIP call setup packets that it transmits over network 32. The user of computer 34 will then receive a message indicating that a VoIP call is coming in from this user.

Although the embodiments described above refer specifically to USB phone 22 and to certain other specific hardware and software elements, the principles of the present invention are similarly applicable to other types of digital telephone terminals, and to other hardware and software components, interfaces and standards, as are known in the art. It will thus be appreciated that the embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

1. A computer-implemented method for communication, comprising:
coupling a computer to communicate over a circuit-switched telephone network via voice-band analog modem hardware;
coupling a communication terminal to exchange digital voice samples with the computer via a digital interface; and
establishing a telephone call via the computer between the communication terminal and a telephone on the circuit-switched telephone network wherein the voice-band analog modem hardware transmits and receives voice signals corresponding to the digital voice samples over the circuit-switched telephone network to and from the telephone.

2. The method according to claim 1, wherein coupling the communication terminal comprises connecting a digital telephone terminal to a digital input/output (I/O) port of the computer.

3. The method according to claim 2, wherein the digital I/O port comprises a Universal Serial Bus (USB) port.

4. The method according to claim 2, wherein the digital I/O port comprises at least one of a computer bus connection and a digital audio connection.

5. The method according to claim 2, and comprising establishing a Voice over Internet Protocol (VoIP) call via the computer between the digital telephone terminal and a remote communication terminal over a packet-switched network.

6. The method according to claim 5, wherein establishing the VoIP call comprises receiving at the computer, via the digital I/O port, an input corresponding to one or more keystrokes input by a user of the digital telephone terminal, and processing the input, using the computer, so as to determine whether to establish the telephone call or the VoIP call.

7. The method according to claim 5, wherein establishing the telephone call comprises driving the communication terminal, using the computer, to generate a first audible indication to indicate that the telephone call has been received from the circuit-switched communication network, and wherein establishing the VoIP call comprises driving the communication terminal, using the computer, to generate a second audible indication, different from the first audible indication, to indicate that the VoIP call has been received from the circuit-switched communication network.

8. The method according to claim 1, wherein coupling the communication terminal comprises setting up a link between the communication terminal and the computer via a packet network.

9. The method according to claim 8, wherein setting up the link comprises establishing a Voice over Internet Protocol (VoIP) call between the communication terminal and the computer.

10. The method according to claim 1, wherein establishing the telephone call comprises conveying the digital voice samples in the computer between a modem driver program that is used to control the voice-band analog modem hardware and a soft phone application program via an audio driver program.

11. The method according to claim 10, wherein establishing the telephone call comprises controlling the telephone call using a soft phone agent, and wherein the digital voice samples are conveyed between the modem driver program and the audio driver program via the soft phone agent.

12. The method according to claim 1, wherein establishing the telephone call comprises receiving a caller identification (CID) signal from the telephone over the telephone network, and outputting a message via the digital interface so as to cause the communication terminal to display information corresponding to the CID signal.

13. The method according to claim 1, wherein the voice-band analog modem hardware is configured to operate in conjunction with a software modem.

14. Apparatus for communication, comprising:
a communication terminal; and
a computer, which comprises:
a digital interface, which is arranged to exchange digital voice samples with the communication terminal; and
voice-band analog modem hardware, which is arranged to communicate over a circuit-switched telephone network,
the computer being arranged to establish a telephone call between the communication terminal and a telephone on the circuit-switched telephone network wherein the voice-band analog modem hardware transmits and receives voice signals corresponding to the digital voice samples over the circuit-switched telephone network to and from the telephone.

15. The apparatus according to claim 14, wherein the digital interface comprises a digital input/output (I/O) port of the computer, and wherein the communication terminal comprises a digital telephone terminal, which is connected to the digital I/O port.

16. The apparatus according to claim 15, wherein the digital I/O port comprises a Universal Serial Bus (USB) port.

17. The apparatus according to claim 15, wherein the digital I/O port comprises at least one of a computer bus connection and a digital audio connection.

18. The apparatus according to claim 15, wherein the computer is further arranged to establish a Voice over Internet Protocol (VoIP) call between the digital telephone terminal and a remote communication terminal over a packet-switched network.

19. The apparatus according to claim 18, wherein the computer is arranged to receive, via the digital I/O port, an input corresponding to one or more keystrokes input by a user of the digital telephone terminal, and to process the input so as to determine whether to establish the telephone call or the VoIP call.

20. The apparatus according to claim 18, wherein the computer is arranged to drive the communication terminal to generate a first audible indication to indicate that the telephone call has been received from the circuit-switched communication network, and to generate a second audible indication, different from the first audible indication, to indicate that the VoIP call has been received from the circuit-switched communication network.

21. The apparatus according to claim 14, wherein the digital interface is arranged to exchange the digital voice samples with the communication terminal via a packet network.

22. The apparatus according to claim 21, wherein the computer is arranged to establish a Voice over Internet Protocol (VoIP) call with the communication terminal over the packet network.

23. The apparatus according to claim 14, wherein the computer is arranged to convey the digital voice samples between a modem driver program that is used to control the voice-band analog modem hardware and a soft phone application program via an audio driver program.

24. The apparatus according to claim 23, wherein the computer is arranged to control the telephone call using a soft phone agent, and wherein the digital voice samples are conveyed between the modem driver program and the audio driver program via the soft phone agent.

25. The apparatus according to claim 14, wherein the computer is arranged to receive a caller identification (CID) signal from the telephone over the telephone network, and to output a message via the digital interface so as to cause the communication terminal to display information corresponding to the CID signal.

26. The apparatus according to claim 14, wherein the voice-band analog modem hardware is configured to operate in conjunction with a software modem.

27. A computer software product, comprising a computer-readable medium in which program instructions are stored, which instructions, when read by a computer, cause the computer to communicate over a circuit-switched telephone network via voice-band analog modem hardware, and to exchange digital voice samples with a communication terminal via a digital interface, and to establish a telephone call between the communication terminal and a telephone on the circuit-switched telephone network wherein the voice-band analog modem hardware transmits and receives voice signals corresponding to the digital voice samples over the circuit-switched telephone network to and from the telephone.

28. The product according to claim 27, wherein the digital interface comprises a digital input/output (I/O) port of the computer, and wherein the communication terminal comprises a digital telephone terminal, which is connected to the digital I/O port.

29. The product according to claim 28, wherein the digital I/O port comprises a Universal Serial Bus (USB) port.

30. The product according to claim 28, wherein the digital I/O port comprises at least one of a computer bus connection and a digital audio connection.

31. The product according to claim 28, wherein the instructions cause the computer to establish a Voice over Internet Protocol (VoIP) call between the digital telephone terminal and a remote communication terminal over a packet-switched network.

32. The product according to claim 31, wherein the instructions cause the computer to receive, via the digital I/O port, an input corresponding to one or more keystrokes input by a user of the digital telephone terminal, and to process the input so as to determine whether to establish the telephone call or the VoIP call.

33. The product according to claim 31, wherein the instructions cause the computer to drive the communication terminal to generate a first audible indication to indicate that the telephone call has been received from the circuit-switched communication network, and to generate a second audible indication, different from the first audible indication, to indicate that the VoIP call has been received from the circuit-switched communication network.

34. The product according to claim 27, wherein the instructions cause the computer to exchange the digital voice samples with the communication terminal via a packet network.

35. The product according to claim 34, wherein the instructions cause the computer to establish a Voice over Internet Protocol (VoIP) call with the communication terminal over the packet network.

36. The product according to claim 27, wherein the instructions cause the computer to convey the digital voice samples between a modem driver program that is used to control the voice-band analog modem hardware and a soft phone application program via an audio driver program.

37. The product according to claim 36, wherein the instructions cause the computer to control the telephone call using a soft phone agent, and wherein the digital voice samples are conveyed between the modem driver program and the audio driver program via the soft phone agent.

38. The product according to claim 27, wherein the instructions cause the computer to receive a caller identification (CID) signal from the telephone over the telephone network, and to output a message via the digital interface so as to cause the communication terminal to display information corresponding to the CID signal.

39. The product according to claim 27, wherein the instructions further cause the computer to operate the voice-band analog modem hardware in conjunction with a software modem.
